(19) United States
(12) Patent Application Publication
(10) Pub. No.: US 2016/0035034 A1
(43) Pub. Date: Feb. 4, 2016

(54) High Volume Capital Investment Aggregation System and Method

(71) Applicant: Arun Mathews, II, Midland, TX (US)

(72) Inventor: Arun Mathews, II, Midland, TX (US)

(21) Appl. No.: 14/531,179

(22) Filed: Nov. 3, 2014

Related U.S. Application Data
(60) Provisional application No. 62/032,740, filed on Aug. 4, 2014.

(51) Int. Cl. G06Q 40/06

(52) U.S. Cl. CPC G06Q 40/06

(57) ABSTRACT

A network based system for presenting subscribers of a crowdfunding platform with an aggregation of entrepreneurial project funding opportunities derived from various sources and delivering to subscribers social media content associated with the entrepreneurial project funding opportunity and award notifications based on the level of subscriber contribution.

### PRIORITY

This application claims priority to Provisional Application 62/032,740, filed Aug. 4, 2014, the entirety of which is hereby incorporated by reference.

### TECHNICAL FIELD

This disclosure relates generally to systems and methods from providing a network based platform for presenting users with an aggregation of entrepreneurial project funding opportunities derived from various sources.

### DESCRIPTION OF RELATED ART

Commercial enterprises attempt various methods for raising operating capital. One such practice is known as crowdfunding. Crowdfunding enables a commercial enterprise to reach a high volume of potential investors to raise significant capital in small increments. Those attempting to increase the success rate of raising capital need to drive engaged traffic to crowdfunding opportunities while keeping operating costs down. Consequently, it is desirable to provide a system and method to maximize investment realization while controlling costs.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings , wherein:

FIG. 1 is a block diagram of an embodiment of the present crowdfunding aggregation system.

FIG. 2 is a block diagram of an embodiment of the functionality of a crowdfunding aggregation server of the present crowdfunding aggregation system.

FIG. 3 is a flow diagram of a process of the present crowdfunding aggregation system.

FIG. 4 is a flow diagram of a process of the present crowdfunding aggregation system.

### DESCRIPTION OF THE EMBODIMENTS

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

In one embodiment of the presently disclosed system, various crowdfunding opportunities from various sources and various platforms are presented to a user. Crowdfunding refers to the practice of raising capital for an endeavor through wide distribution of investment opportunities to potential investors. In the crowdfunding context, an investor does not typically receive stock or equity in the enterprise seeking funding in exchange for providing capital. Instead, the investor may receive a reward or item in exchange for the investment, depending upon the level of investment. For example, a user investing in an animated version of an educational text book may receive a copy of the textbook signed by the author in exchange for a certain level of investment. A higher investment may entail a more significant reward. The platform is highly customizable, enabling the crowdfunding solicitor to designate appealing rewards at various levels of investment. Investing as used herein refers to traditional investing wherein some consideration, in the form of stock, an item, etc. is received in return for the investment as well as a pure donation wherein no consideration is returned.

The crowdfunding opportunity is typically made available to users over a wide area network, such as the Internet. The crowdfunding aggregations platform described herein, in one embodiment, leverages user data collected from a variety of sources to predict areas of user interest and subsequently deliver content related to relevant funding opportunities to the user via the system in which aggregated crowdfunding opportunities are presented to a user. The platform retrieves and aggregates relevant crowdfunding opportunities from existing crowdfunding sources and provides collective access to those opportunities to the user via a single interface. Enterprises attempting to raise capital may subscribe to the crowdfunding aggregation described herein. An enterprise may pay the platform provider a periodic flat fee for inclusion of a single or multiple investment opportunities. Alternatively, the enterprise may pay the platform provider based on significant visits by the user to a particular crowdfunding opportunity. In one embodiment, a user is presented via a user interface with an array of links to various crowdfunding opportunities. The links may be in the form of hyperlinks comprised of a uniform resource locator that a user may simply activate with a user interface device (such as a computer mouse), or the link may be in the form of a thumbnail image that when activated by the user causes a multimedia file, such as a video file of the variety that may be seen on YouTube. In one embodiment, an introduction of the substance of the crowdfunding opportunity may be presented to the user as a preview of the video file. If the introduction piques the user's interest in the opportunity and the user wishes to continue viewing the crowdfunding piece, then the enterprise will be charged for that user's viewing. The system may differentiate an interested user (i.e., viewing charged to the enterprise) based on the duration of the user's viewing of the opportunity. Alternatively, the user may be provided with only a textual of multimedia summary of the opportunity and if the user's interest in the opportunity is piqued, then the user may activate a link (URL), icon, thumbnail or other feature that will provide access to the full video description of the crowdfunding opportunity. Once the full feature is activated, the enterprise is charged for that user's visit. The system described herein advantageously eliminates cost to the enterprise for cruising or browsing by casual users. Alternatively, the user, rather than the enterprise may be charged for the use of the present crowdfunding aggregation system, with payment made via a subscription basis, on a per use basis, or as a component or percentage of any investment in the subject crowdfunding opportunity that the user may make. In one embodiment, the disclosed systems and methods are suited for use in conjunction with a computerized crowdfunding aggregation system that operates over a wide area communication network such as the Internet.

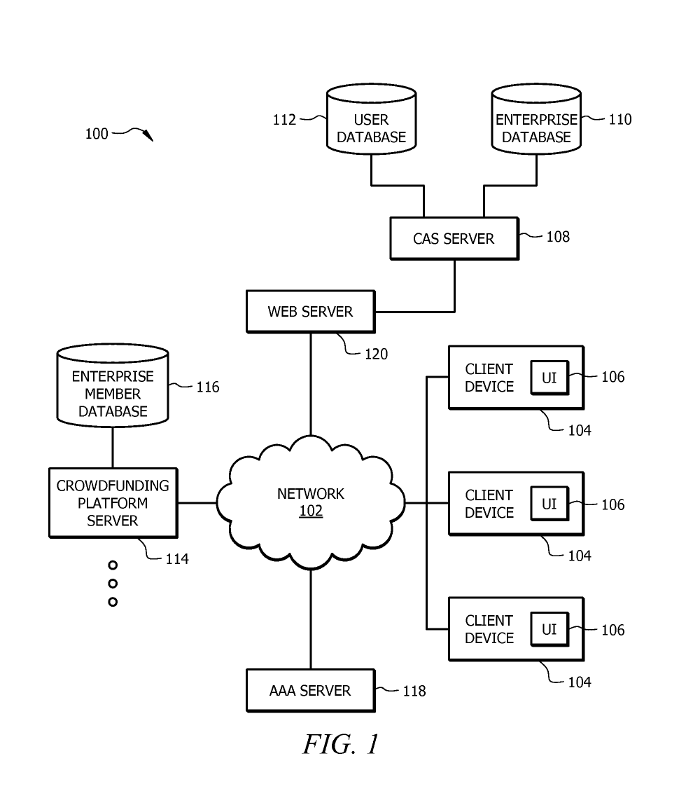

Crowdfunding aggregation system (CAS), through which an enterprise reaches potential investors to raise capital in a crowdfunding context is implemented in one embodiment depicted in FIG. 1. In one embodiment, the CAS operates over a wide area communication network such as the Internet, a description of an exemplary network and corresponding components is provided as FIG. 1. In FIG. 1, an exemplary network 100 is shown according to the disclosed embodiments. As can be seen, the network 100 may have a plurality of client devices 104 connected to, for example, a crowdfunding aggregation system (CAS) server 108 hosted by at least one web server 120 with a user database 112 and enterprise database 110 connected thereto. The plurality of client devices 104 may be any system, device, and/or any combination of devices/systems that are able to establish a connection with another device, a server and/or other systems. Client device 104 typically includes display or other output functionalities to present data exchanged between the device and a user. For example, the client devices may be, but are not limited to, a server, a desktop computer, a computer cluster, a mobile computing device such as a notebook, a laptop computer, a handheld computer, a mobile phone, a smart phone, a PDA, an iPhone, etc. In one embodiment, the client devices 104 are coupled to the network 102. In some embodiments, the client devices may be directly connected to one another. In the example shown, the computing devices 104 represent individual users (i.e., potential investors) who are investigating investment crowdfunding investment opportunities to.

Each computing device 104 may connect to a CAS website via associated web server 120 over a respective network connection which may be a telephone line connection, high speed broadband connection, or wireless connection, or combinations thereof. Of course, those of ordinary skill in the art will recognize that the types of computing devices and associated network connection may vary without departing from the scope of the disclosed embodiments. Enterprises seeking funding or investment from users in a crowdfunding capital raising environment may connect to the CAS server 108 and ultimately reach users through client devices 104 over network. 102. Network 102 may be a telephonic network, an open network, such as the internet, or a private network, such as an intranet and/or the extranet. Network 102 may be a collection of various individual networks operating in conjunction to provide connectivity to the client devices and servers, and may be recognized as one or more networks to the serviced systems and devices. Connectivity may be established by a secure communication protocol. In another embodiment, communication may be achieved via one or more wireless networks. Client devices 104 may be coupled to network 102 via the Internet, dial-up connection, digital subscriber loop (DSL, ADSL), cable modem, and/or other types of connection. Client devices 104 may communicate with remote servers that provide access to user interfaces to the Internet via a web browser.

Crowdfunding platform server (CPS) 114 is an individual crowdfunding platform though which an enterprise may solicit for funds from users in a crowdfunding context to capitalize a commercial endeavor. In one embodiment, CPS 114 delivers requested and relevant content CAS 108 via network 102. CAS 108 may be a combination of software agents and/or hardware modules for establishing a crowdfunding based platform for users. CAS 108 may facilitate interaction and communication among users of the client devices 104, with CPS 114, with AAA server 118 or with other related applications and/or systems through network 106. For example, CAS 108 may provide a platform for users of the client devices 104 who are members of a single crowdfunding service provider or the crowdfunding aggregation service to request investment opportunities for a single opportunity from a single provider a collection of opportunities from a single provider or several providers. In the latter instance, the multiple opportunities responsive to a user request are aggregated and presented to the user at interface 106 of client device 104 to allow the user to determine which opportunities are of interest. Associated with CAS 108 is an enterprise database 110. Enterprise database 110 may store information such as software, descriptive data, images, system information, drivers, and/or any other data item utilized by the web server 120, CAS Server 108, CPS Server 114 or Authentication, Authorization and Accounting (AAA) server 118. Enterprise database 110 may be managed by a database management system (DBMS), for example but not limited to, Oracle, DB2, Microsoft Access, Microsoft SQL Server, PostgreSQL, MySQL, FileMaker, etc. CAS 108 manages and delivers crowdfunding content retrieved from crowdfunding service providers to requesting users via network 102. CAS 108 makes crowdfunding content from external crowdfunding service providers, in the form of a multimedia files for viewing, presented to the user at client device 104.

In one embodiment, user database 112 associated with CAS 108 includes user account information, user login information and in one embodiment various preferences selected by the user to permit CAS 108 to filter crowdfunding opportunities from various sources according to user preferences. In one embodiment, CAS 108 creates a user profile stored in user database 110 corresponding to a user's history of activities, including a user's activities on various social media outlets. CAS 108 uses the profile information to present the user at client device 104 with an aggregation of crowdfunding opportunities reflecting the user's perceived interests. Further, CAS 108 may interact with AAA server 118 to execute financial transactions in response to user interaction with CAS 108 while analyzing crowdfunding opportunities. For example, if a user selects a crowdfunding opportunity of a particular crowdfunding source through CAS 108, and the user's interaction with the multimedia content associated with the opportunity exceeds a threshold time duration, then a debt is applied to the crowdfunding source's account maintained in enterprise database 110 associated with CAS 108 and a corresponding credit is applied for the crowdsourcing aggregation service provider in enterprise database 110. In addition, if a user opts to invest in a particular crowd sourcing opportunity presented at user interface 106, then the user's account is debited appropriately and the debt entry is stored at user database 112 associated with CAS 108. Periodically, the crowdfunding service provider's and/or user's debts are reconciled via interaction with AAA server 118.

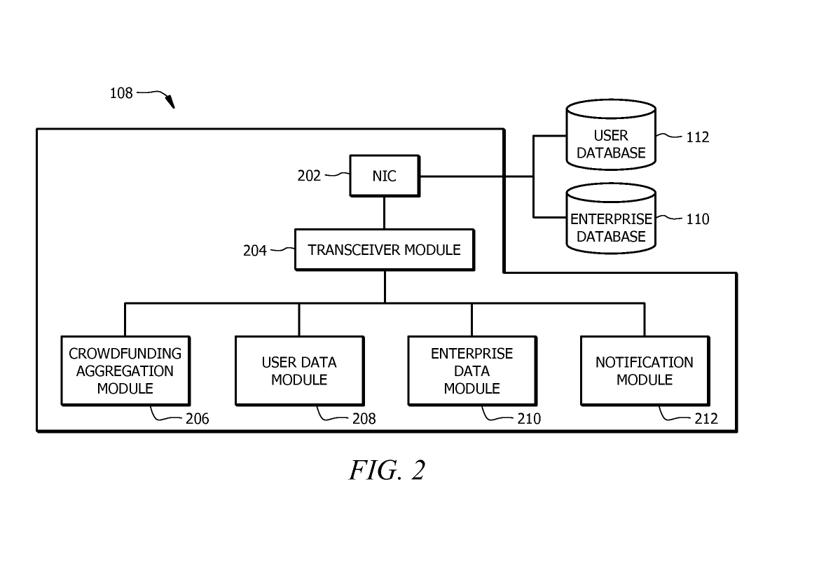

FIG. 2 depicts a system for providing an aggregation of crowdfunding opportunities generated by one or more external sources. FIG. 2 depicts various components of CAS 108. CAS 108 includes a network interface 202, receive and transmit (transceiver) module 204, a crowdfunding aggregation module 206, a user data module 208, an enterprise data module 210, and notification module 212. Additional modules or fewer modules may be included. The CAS 108 may be communicatively coupled to enterprise database 110, or user database 112 as shown in FIG. 2 and may be in whole or in part internal to CAS 108.

Network interface 202 may be one or more networking devices that enable CAS 108 to transmit data in a network with an entity that is external to the server, through any communications protocol supported by the server and the external entity. Network interface 202 may include, but is not limited to, one or more of a network adaptor card, wireless network interface card, router, access point, wireless router, switch, multilayer switch, protocol converter, gateway, bridge, bridge router, hub, digital media receiver, and/or repeater.

CAS 108 includes a transceiver module 204 or a combination modules communicatively coupled to the network interface 202 to manage a unilateral, bilateral or multilateral communications over multiple communications protocols. In one embodiment, the transceiver s module 204 receives data, information, commands, requests, and/or text-based messages over a network. In one embodiment, the transceiver module 204 receives communications from a network (e.g., internet, wired and/or wireless network) initiated via a web-interface. As the transceivers module 204 is typically compatible with receiving and/or interpreting data of various communication protocols, the transceiver module 204 is able to establish communication sessions with users of remote client devices for data and command exchange (e.g., user information and/or user content). Transceiver module 204 can manage log-on requests received from one or more users or crowdfunding service providers interfacing with CAS 108 including, but not limited to, making new crowdfunding opportunities available to CAS, entering a user data and profile information, reviewing user data for preferences, or providing information to be included in a notification to be sent to a user. Authenticated sessions may be managed by transceiver module 204 for user login.

CAS 108 may utilize a username/email and password identification method for authorizing access. Transceiver module 204 analyzes entered information to determine if a user is authorized to access the system and if so, securely logs the user into the system. In other embodiments, other forms of identity authentication, such as security cards and/or digital certificates may be utilized. A user may be able to specify and/or obtain a logon ID after subscribing with CAS or an affiliated crowdfunding service provider partner. The communications module 220 may also establish communication sessions with a social network platform (not shown) to transmit customized advertisements for displaying information about a crowdfunding opportunity on a webpage of similar interface of a social networking site frequented by a user or potential user or to transmit or receive information about participants.

In one embodiment, CAS 108 includes crowdfunding aggregation module 206. Crowdfunding aggregation module 206 may be any combination of software agents and/or hardware components able to request, receive, compile, aggregate and display information from a crowdfunding service providers about the investment opportunities. Based upon requests received by a user via client device 104 and user interface 106, crowdfunding aggregation module 206 generates a customized online crowdfunding resource as an independent webpage or as reflecting crowdfunding opportunities available based on received user request or based on information gleaned from user data stored in associated user data module 208. Crowdfunding aggregation module 206 collects relevant crowdfunding opportunities from one or more CPS 114 and makes multimedia files reflecting the multiple funding opportunities available to the user via a single webpage or user interface. Crowdfunding opportunities are made available to the present crowdfunding aggregation system in real-time as they become available. The system provides the capability for the user to refresh a webpage visited by the user containing links to available opportunities to add new opportunities available to the user. In one embodiment, crowdfunding aggregation module 206 transmits to a social network server information reflecting new crowdfunding investment opportunities available via CAS 108. The social network server, in turn, transmits relevant crowdfunding information to social network subscribers based on user define criteria or analyzed areas of interest. Through a social media interface, such as a webpage or mobile application interface, a user may access the crowdfunding aggregation system to investigate investment opportunities.

The software agents and/or hardware components of crowdfunding aggregation module 206 also enables appropriate charging of users and/or crowdfunding service provider based on investment commitments by a user and crowdfunding site investigation. Specifically, based on a user's visit to a multimedia presentation of a crowdfunding opportunity a crowdfunding service provider will be charged by the crowdfunding aggregation system a fee in the event that a user views multimedia content, such as a video, describing the funding opportunity longer than a predefined duration. In one embodiment, if a user commits to fund a particular endeavor, the crowdfunding aggregation module 206 will charge the user for the appropriate amount either through charging a credit or debit card provided by the user in conjunction with AAA capability residing on associated AAA server 118 or through other fund transfer means. Ultimately, investments made in a particular investment opportunity are transferred to the appropriate crowdfunding service provider, and the operator of the present crowdfunding aggregation service retains any fees incurred by the crowdfunding service provider.

In one embodiment, CAS 108 includes a user data module 208, an enterprise data module 210 and a notification module 212. These modules 208, 210 and 212 may comprise any combination of software agents and/or hardware components able to request, receive, compile, aggregate and display information relevant to providing crowdfunding opportunity information to a user. User data module 208 collects and analyzes user information from a variety of sources including user profile information received from a user upon enrollment with the present crowdfunding aggregation system or crowdfunding service provider, or from information collected and processed based on user activity. Enterprise data module 210 collects and analyzes data from a plurality of enterprises seeking funding via a crowdfunding service provider. This functionality includes suggesting funding opportunities to users based on user and enterprise attributes. Notification module 212 generates various informational messages for users, enterprises and crowdfunding service providers that include status of fundraising efforts, funds owed the crowdfunding aggregation system, promotional information or other relevant information.

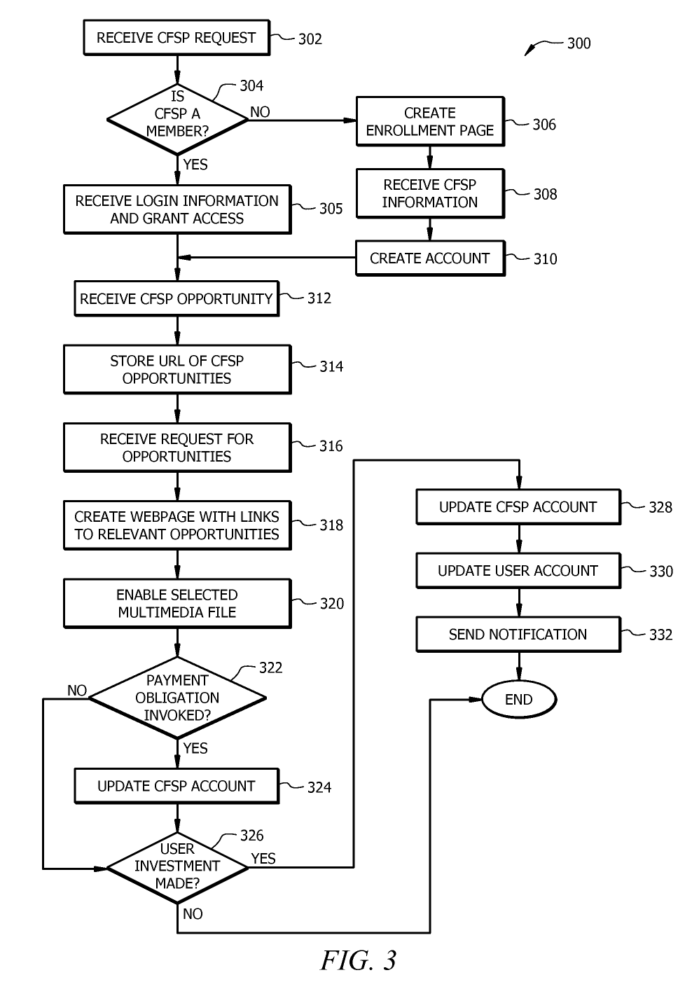

FIG. 3 depicts a flowchart of the processes performed by one or more of the various described modules of the present crowdfunding aggregation system. One embodiment of the process performed by the presently disclosed crowdfunding aggregation system starts at step 300 with the system receiving a request from u crowdfunding service provider (CFSP). This request can result from a visitor to the crowdfunding aggregation system website activating some live key or link on the webpage. If the aspect of the webpage activated by the CFSP requires user login to proceed, then the system queries at step 304 if the requesting CFSP is enrolled in the crowdfunding aggregation system. When the visitor is a CFSP representative, the request typically entails adding a crowdfunding investment opportunity to the crowdfunding aggregation system or accessing CFSP account information. If the CFSP user is enrolled, the CFSP user is presented with a login window in which the CFSP user logs into the crowdfunding aggregation system. In one embodiment, this entails CFSP user entry of previously identified indicia of credentials. At step 305, if the entered information received matches enrollment data previously stored in a database, the user is granted access to the crowdfunding aggregation system and the process proceeds to step 312. If the CFSP user is nota crowdfunding aggregation system member, then at step 306 the crowdfunding aggregation system creates an enrollment page through which the CFSP may register as a crowdfunding aggregation system member crowdfunding source. The CFSP user provides requested information including but not limited to company name, address, contact information, email information, website information, and other information that will permit interaction between the CFSP's crowdfunding platform server 114 and the crowdfunding aggregation system to provide investment multimedia files to the latter to present to potential investors. At step 308, the crowdfunding aggregation system receives the entered CFSP information and at step 310 the crowdfunding aggregation system creates an account for the newly enrolled CFSP user. Along with account creation at step 310, the crowdfunding aggregation system stores the CFSP information in database 110 or 112 and initiates various account parameters. In one embodiment, payment capability to and from the CFSP is enabled to facilitate payment of fees by the CFSP to the crowdfunding aggregation system based on user activation and significant viewing of multimedia files describing investment opportunities. Similarly, the payment capability will allow transfer of user funds reflecting investments made through the crowdfunding aggregation system.

Once the CFSP user is granted access to the crowdfunding aggregation system, the user may input information related to a CFSP opportunity at step 312. This information is provided to the crowdfunding aggregation system in one embodiment via a fillable webpage. The information provided with respect to the investment opportunity may include the specifics about the opportunity such as the endeavor for which funding is sought, the amount of funding sought, the various rewards given to users for various levels of investment, any limitations on the number of awards available, and the like. The information also includes a URL or other means to gain access a multimedia file, such as a video clip playable by know media player applications that describes the nature of the commercial endeavor. At step 314, the information provided by the CFSP related to the investment opportunity is stored in database 110 or 112.

Once the crowdfunding aggregation system is associated with at least one CFSP funding opportunity through the various steps provided above, the process proceeds to step 316 where the crowdfunding aggregation system receives a request from a user to investigate a crowdfunding opportunity. Assuming the user is a registered user and is granted access to the crowdfunding aggregation system in a manner known in the art, the process continues with step 318 where crowdfunding aggregation system creates a webpage containing links to relevant crowdfunding investment opportunities. At step 320, upon receipt of indication of selection by the user of a link associated with a particular opportunity, the crowdfunding aggregation system creates a webpage containing links to relevant crowdfunding investment opportunities. At step 320, upon receipt of indication of selection by the user of a link associated with a particular opportunity, the system continues at step 320 with enablement of the selected multimedia file. In this step, a user is presented with an indication of a multimedia file playable by a common multimedia application. The indication may be a thumbnail containing a screenshot of the contents of the multimedia file.

In one embodiment, and as depicted, once the user initiates playing of the multimedia file, the system queries at step 322 whether the CFSP payment threshold has been surpassed. Whether the payment threshold has been surpassed can be determined by a variety of factors that may be established upon enrollment in the crowdfunding aggregation system by the CFSP. In one embodiment, the CFSP may be obligated to pay a fee to the crowdfunding aggregation system provider if a user views a multimedia or video presentation describing an investment opportunity for a time that surpasses a predefined duration. A CFSP may opt to pay a lower fee per user visit if a relatively low viewing time threshold is established or a higher fee if a relatively higher viewing time threshold is established. In another embodiment, the CFSP may receive a volume discount based on the number of enrollment opportunities offered by the CFSP through the crowdfunding aggregation system. Or, the crowdfunding aggregation system may offer a premium enrollment plan where the CFSP member may pay a flat periodic fee for unlimited user visits or deeply discounted visits. Such premium enrollment may also give the associated CFSP priority or preferred listing among investment opportunities presented to a user.

If in response to query 322 the CFSP payment obligation has been not been invoked, the method proceeds to step 326, described below. If, on the other hand, the CFSP payment obligation has not been invoked, then the CFSP account is updated accordingly at step 324 to reflect the debt accrued. The crowdfunding aggregation system may invoke functionality in accordance with AAA protocols to execute completion of payment utilizing financial data previously provided by the CFSP, such as bank account information to execute an electronic transfer of funds or debit or credit card information and the like.

The process continues at step 326 where the crowdfunding aggregation system queries whether the user has made an investment in a particular crowdfunding opportunity. Once a user views all or part of a multimedia file, the user is presented with a link, soft key or activation tab on a webpage created at step 318 in one embodiment through which the user may interact via user interface 106. If the answer to the query at step 326 is negative that the user has not made an investment in a crowdfunding endeavor via the crowdfunding aggregation system, then the process ends. If the user has made an investment via the crowdfunding aggregation system, however, the method proceeds to step 328 in which the account of the CFSP for which an investment was made is updated to reflect the level of investment made by the user. The CFSP account may also be updated to reflect any other fees incurred during the user session, any reduction in available awards available to investors or other discounts offered to the CFSP based on any promotions offered by the crowdfunding aggregation system operator. If funds invested are paid through the crowdfunding aggregation system rather than directly to the CFSP, then the crowdfunding aggregation system will employ known payment methods using established payment parameters between the crowdfunding aggregation system and the CFSP. The execution of payments will be performed in accordance with AAA protocols. The CFSP account will be updated to reflect this transaction. The CFSP account will also be modified to reflect to total amount of investments received and the amount necessary for the enterprise to reach its funding goal.

In one embodiment, the method then proceeds to step 330 in which a user account is updated. The user account is updated to provide information related user requests and investment levels. As discussed above, if the crowdfunding aggregation system serves as the intermediary for the transfer of funds between the user and the CFSP (and ultimately the party seeking funding), the crowdfunding aggregation system will facilitate transfer of payment through payment parameters established at the time of user enrollment.

Next, the method proceeds to step 332 where notifications are sent to the user and CFSP. In one embodiment, these notifications include a receipt for the user and an indication to the CFSP that investment has been made. The notification will also indicate the level of reward or prize for which the user is eligible based on the level of investment.

Note, while an embodiment has been described wherein an investment is made via the crowd funding aggregating system (CAS), this is for illustrative purposes only and should not be deemed limiting. In other embodiments, for example, investments occur at the CFSP. In such embodiments, users will view and have access to the opportunities through the crowd funding aggregating system, but if the users are interested in more information, or if they are interested in investing, they are directed to the CFSP via a link, transfer, or any other device or method known in the art.

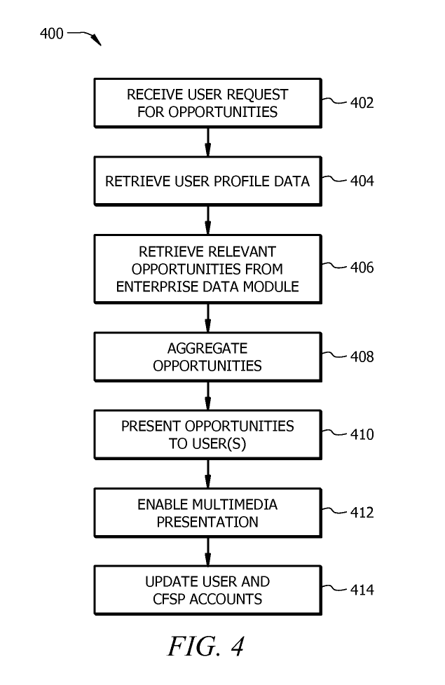

In another embodiment of the crowdfunding aggregation system, the investment opportunities presented to a user may be customized according to profile data provided by a user or compilation based on user activity. FIG. 4 is a flowchart comprising steps of a method of an embodiment of the crowdfunding aggregation system. In FIG. 4, assuming that several CFSPs and users have successfully enrolled in the crowdfunding aggregation system and a user is presently logged into the crowdfunding aggregation system, the process begins at step 402 where the crowdfunding aggregation system receives a user request for funding opportunities. The request may be submitted simply by depression of a tab presented in a webpage that provides a full list of active opportunities. In another embodiment, the user may be presented with a search window in which the user may enter search terms of interest and the crowdfunding aggregation system employs known search engine functionality to search the enterprise database 110 for opportunities that reflect the search terms. Once the crowdfunding aggregation system identifies potential opportunities responsive to the user's request, the user retrieves at step 404 user profile data for the active user in user database 112. This profile data may be data entered by the user upon enrollment or data compiled based on prior user searches or social media activity reported to the CAS 108 by a social media server (not shown) or a combination of this information. Profile data may include user age or other demographic information as well as the geographic location of the user. The crowdfunding aggregation system through the user data module leverages this data to identify other investment opportunities not necessarily identified as a result of the search term process described above but that are deemed relevant or potentially of interest based on data associated with the user profile.

Based on the requested opportunities and opportunities potentially of interest, the crowdfunding aggregation system at step 406 retrieves indicia of the opportunities from enterprise data module 210. Enterprise data module 210 includes URL information that may be embedded in a HTML webpage via a variety of techniques. Once the list of requested opportunities and potential opportunities is complete, the indicia of the opportunities are aggregated by the crowdfunding aggregation system and presented to the user at step 410 in a single webpage. The funding opportunities may be sourced to a single CFSP or multiple CFSPs.

Once the various opportunities are made available to the user for selection via a textual description, link, thumbnail, series of short videos, or the like, the user's selection of a particular opportunity to investigate prompts the crowdfunding aggregation system to a step 412 enable a multimedia presentation reflecting the substance of the opportunity that the user may view. Once a user views a presentation, the process proceeds with steps as described with reference to FIG. 3 with respect to determining whether a payment obligation of the CFSP has been invoked due to duration of user viewing or whether a user investment has occurred. At the conclusion of the user's viewing session, the user and CFSP accounts are updated to reflect pertinent activity.

The CAS 108, in an embodiment, is able to retrieve and store data relevant to a particular user subscriber from a social network server and (not shown) social network user database (not shown). In some embodiments, a social network server is able to retrieve and store user or CFSP data from the crowdfunding aggregation system in order to facilitate submitting indicia of investment opportunities to users via a social network platform available via Internet of mobile networks employing relevant applications. In these instances, the crowdfunding aggregation system leverages social media platforms as the interface with the user to initiate funding and investment activities.

In one embodiment, the crowdfunding aggregation system utilizes advertising. Those skilled in the art will understand the various revenue streams that can originate from advertising. The CAS can be, for example, paid an advertising fee if a user clicks on one of the presented opportunities, or if a user watches a specified length of the opportunity. Virtually any method of calculating compensation based on advertisement can be utilized. In such embodiments the CAS provides users an opportunity to show-case their specific opportunity, as well as drive traffic and attention to their opportunity. Increased traffic, in one embodiment, increases the likelihood that an opportunity will become funded. The advertising revenue can originate from a variety of sources, including, but not limited to, the user providing the opportunity, the service hosting the opportunity, advertisers who advertise on the host, third-party advertisers, etc. Accordingly, in one embodiment the CAS provides an advertising platform for crowdfunding projects.

While the disclosed embodiments have been described with reference to one or more particular implementations, these implementations are not intended to limit or restrict the scope or applicability of the invention. Those having ordinary skill in the art will recognize that many modifications and alterations to the disclosed embodiments are available. Therefore, each of the foregoing embodiments and obvious various thereof is contemplated as falling within the spirit and scope of the disclosed inventions.

### ADDITIONAL DESCRIPTION

The following clauses are offered as further description of the disclosed invention.

Clause 1. A computer implemented high volume funding method, comprising:
receiving from a first provider of a high volume funding platform a request to associate a first funding offering with a second funding offering sourced to a second provider of a high volume funding platform;
presenting to a subscriber user a plurality of funding offerings including a plurality of links providing access to a corresponding plurality of multimedia data associated with the plurality of funding offerings;
executing a multimedia data file in response to activation of at least one of the plurality of links;
comparing the duration of a user's interaction with the executed multimedia data file with a predetermined threshold interaction duration;
updating an account of the high volume funding platform associated with the executed multimedia data file to reflect user interaction in excess of the predetermined threshold; and
updating a user account according to preselected user attributes; and
sending a notification message reflecting user funding of the selected funding offering.

Clause 2. The method of any proceeding or preceding claim, further comprising updating an account of a funding recipient according to a level of funding received by the user.

Clause 3. The method of any proceeding or preceding claim, wherein the notification message includes information of a user reward based on a level of funding received by the user.

Clause 4. The method of any proceeding or preceding claim, further comprising updating of an account of the high volume funding platform to reflect a reward earned by the user.

Clause 5. The method of any proceeding or preceding claim, further comprising aggregating a plurality of funding opportunities according to user attributes.

Clause 6. The method of any proceeding or preceding claim, wherein the step of presenting to a subscriber user a plurality of funding opportunities includes presenting a representative image associated with the funding opportunity.

Clause 7. The method of any proceeding or preceding claim, wherein the multimedia data associated with the plurality of funding opportunities comprises a content retrieved from a social network source.

Clause 8. A funding opportunity aggregation system, comprising:
an enrollment server that provides accounting services for a funding platform network

Clause 9. A computer system for high volume funding aggregation, comprising: a hardware server configured to:
receive at least one funding data relating to a first funding recipient;
receive at least one subscriber data relating to at least one subscriber;
debit from a funding recipient account an amount corresponding to a level of the at least one subscriber activity associated with the first funding recipient content;
credit the first funding recipient account according to a level of the at least one subscriber contribution to the first funding recipient; and
deliver a multimedia data to the at least one subscriber according to activation by the subscriber of a representation of the multimedia data.

Clause 10. The system of any proceeding or preceding claim, further comprising a hardware server configured to allocate an award to the at least one subscriber based on a level of funding received by the first funding recipient.

Clause 11. The system of any proceeding or preceding claim, further comprising a hardware server configured to aggregate a funding opportunity of the first funding recipient and a funding opportunity of a second funding recipient.

Clause 12. The system of any proceeding or preceding claim, further comprising a hardware server configured to present to the at least one subscriber a plurality of representations corresponding to the funding opportunity of the first funding recipient and the funding opportunity of the second funding recipient.

Clause 13. The system of claim 9, wherein the multimedia data is associated with the funding data of the first funding recipient.

Clause 14. The system of any proceeding or preceding claim, wherein the multimedia data comprises content retrieved from a social network source.

Clause 15. The system of any proceeding or preceding claim, further comprising a hardware server configured to
authenticate a transaction between the at least one subscriber and the first funding recipient based on the received at least one subscriber data and the received at least one funding data.

Clause 16. A non-transitory computer readable medium having computer-readable instructions stored thereon which, when executed by a processor, cause the processor to:
receive at least one funding data relating to a first funding recipient; receive at least one subscriber data relating to at least one subscriber;
debit from a funding recipient account an amount corresponding to a level of the at least one subscriber activity associated with the first funding recipient content;
credit the first funding recipient account according to a level of the at least one subscriber contribution to the first funding recipient; and
deliver a multimedia data to the at least one subscriber according to activation by the subscriber of a representation of the multimedia data.

Clause 17. The non-transitory computer-readable medium of any proceeding or preceding claim, wherein the instructions further cause the processor to:
allocate an award to the at least one subscriber based on a level of funding received by the first funding recipient;
aggregate a funding opportunity of the first funding recipient and a funding opportunity of a second funding recipient;
present to the at least one subscriber a plurality of representations corresponding to the funding opportunity of the first funding recipient and the funding opportunity of the second funding recipient; and
authenticate a transaction between the at least one subscriber and the first funding recipient based on the received at least one subscriber data and the received at least one funding data.

Clause 18. The non-transitory computer-readable medium of any proceeding or preceding claim, wherein the instructions further cause delivery of the multimedia data associated with the funding data of the first funding recipient.

Clause 19. The non-transitory computer-readable medium of any proceeding or preceding claim, wherein the instructions further cause delivery of the multimedia data comprising content retrieved from a social network source.

We claim:

1. A computer implemented high volume funding method, comprising:
receiving from a first provider of a high volume funding platform a request to associate a first funding offering with a second funding offering sourced to a second provider of a high volume funding platform;
presenting to a subscriber user a plurality of funding offerings including a plurality of links providing access to a corresponding plurality of multimedia data associated with the plurality of funding offerings;
executing a multimedia data file in response to activation of at least one of the plurality of links;
comparing the duration of a user's interaction with the executed multimedia data file with a predetermined threshold interaction duration;
updating an account of the high volume funding platform associated with the executed multimedia data file to reflect user interaction in excess of the predetermined threshold; and
updating a user account according to preselected user attributes; and
sending a notification message reflecting user funding of the selected funding offering.

2. The method of claim 1, further comprising updating an account of a funding recipient according to a level of funding received by the user.

3. The method of claim 1, wherein the notification message includes information of a user reward based on a level of funding received by the user.

4. The method of claim 1, further comprising updating of an account of the high volume funding platform to reflect a reward earned by the user.

5. The method of claim 1, further comprising aggregating a plurality of funding opportunities according to user attributes.

6. The method of claim 1, wherein the step of presenting to a subscriber user a plurality of funding opportunities includes presenting a representative image associated with the funding opportunity.

7. The method of claim 1, wherein the multimedia data associated with the plurality of funding opportunities comprises a content retrieved from a social network source.

8. (canceled)

9. A computer system for high volume funding aggregation, comprising: a hardware server configured to:
receive at least one funding data relating to a first funding recipient;
receive at least one subscriber data relating to at least one subscriber;
debit from a funding recipient account an amount corresponding to a level of the at least one subscriber activity associated with the first funding recipient content;
credit the first funding recipient account according to a level of the at least one subscriber contribution to the first funding recipient; and
deliver a multimedia data to the at least one subscriber according to activation by the subscriber of a representation of the multimedia data.

10. The system of claim 9, further comprising a hardware server configured to allocate an award to the at least one subscriber based on a level of funding received by the first funding recipient.

11. The system of claim 9, further comprising a hardware server configured to aggregate a funding opportunity of the first funding recipient and a funding opportunity of a second funding recipient.

12. The system of claim 11, further comprising a hardware server configured to present to the at least one subscriber a plurality of representations corresponding to the funding opportunity of the first funding recipient and the funding opportunity of the second funding recipient.

13. The system of claim 9, wherein the multimedia data is associated with the funding data of the first funding recipient.

14. The system of claim 14, wherein the multimedia data comprises content retrieved from a social network source.

15. The system of claim 9, further comprising a hardware server configured to authenticate a transaction between the at least one subscriber and the first funding recipient based on the received at least one subscriber data and the received at least one funding data.

16. A non-transitory computer readable medium having computer-readable instructions stored thereon which, when executed by a processor, cause the processor to:
receive at least one funding data relating to a first funding recipient; receive at least one subscriber data relating to at least one subscriber;
debit from a funding recipient account an amount corresponding to a level of the at least one subscriber activity associated with the first funding recipient content;
credit the first funding recipient account according to a level of the at least one subscriber contribution to the first funding recipient; and
deliver a multimedia data to the at least one subscriber according to activation by the subscriber of a representation of the multimedia data.

17. The non-transitory computer-readable medium of claim 16, wherein the instructions further cause the processor to:
allocate an award to the at least one subscriber based on a level of funding received by the first funding recipient;
aggregate a funding opportunity of the first funding recipient and a funding opportunity of a second funding recipient;
present to the at least one subscriber a plurality of representations corresponding to the funding opportunity of the first funding recipient and the funding opportunity of the second funding recipient; and
authenticate a transaction between the at least one subscriber and the first funding recipient based on the received at least one subscriber data and the received at least one funding data.

18. The non-transitory computer-readable medium of claim 17, wherein the instructions further cause delivery of the multimedia data associated with the funding data of the first funding recipient.

19. The non-transitory computer-readable medium of claim 18, wherein the instructions further cause delivery of the multimedia data comprising content retrieved from a social network source.
